(19) United States
(12) Patent Application Publication
(10) Pub. No.: US 2003/0114165 A1
(43) Pub. Date: Jun. 19, 2003

(54) Method for enhanced wireless signal distribution

(76) Inventor: Donald Charles Mills, Bedford, NH (US)

Correspondence Address: Donald C. Mills, 22 Spartan Dr., Bedford, NH, 03110, US

(21) Appl. No.: 10/017,279

(22) Filed: Dec. 7, 2001

(51) Int. Cl. H04Q 7/20

(52) U.S. Cl. 455/453; 455/452

(57) ABSTRACT

Subscriber traffic loading in wireless channel sets (31) is indirectly estimated, and distribution of channel sets (31) among regions (39) in the confined space is optimized to more evenly allocate subscribers among those channel sets (31). Multiple service providers, multiple wireless technologies, and both donor-site and in-building micro-cell implementations are supported.

### CROSS-REFERENCE TO RELATED APPLICATIONS

Not applicable.

### BACKGROUND

1. Field of the Invention

This invention relates to a system to increase wireless network capacity within an enclosed area or structure.

2. Description of Prior Art

As wireless communications has become increasingly commonplace, it has become for many users their preferred method of personal communication. Networks to support wireless communications, particularly “Cellular” and “Personal Communications Systems” or PCS are designed to provide service over a wide geographic area using various techniques to re-use the available spectrum within the system coverage area to support as many users as possible with an acceptable level of service quality.

Digital techniques have been widely deployed to increase capacity, to enable new user services, and to provide improved service quality. In many areas, service providers have deployed multiple digital formats. In North America, for example, wireless service is widely available employing diverse technologies including Time Division Multiple Access (TDMA), Code Division Multiple Access (CDMA), Global System for Mobile Communications (GSM), and Integrated Dispatch Enhanced Network (iDEN). Future deployments based on advanced technologies such as CDMA-2000 and W-CDMA are expected to further expand the potential for wireless services.

As service offerings have grown, coverage has expanded, and pricing for services has fallen, wireless communications has become a preferred mode of communications for many individuals. The expectation that a wireless handset will work “any place, any time” has become commonplace. However, this expectation is often not met in indoor environments or in areas with difficult (e.g., hilly or heavily forested) terrain. Many modern building construction materials such as metal and concrete are relatively opaque to radio frequency transmissions, and thus shield the users' handsets from the base stations that provide them service. Many buildings also have significant underground space, providing further impediments to reliable wireless communication.

In these cases and others, it is advantageous to provide wireless coverage in a confined space from within the space, rather than installing a wireless base station site. Common means of providing this coverage include:

1) Install one or more donor antennas outside or above the confined space, which provides a direct signal path to and from an existing base station site. This signal is relayed to and from the user's handset by one or more antennas located within the enclosed space. Such implementations typically employ bi-directional amplifiers to increase the signal level both in the base station to subscriber handset path (downlink) and in the subscriber handset to base station path (uplink). Typically, the donor antenna is aligned to the nearest base station site. Additionally, multiple donor antennas can be used to serve different regions of the enclosed space from different base stations.

2) Install dedicated cellular base stations to serve the enclosed space and employ a Distributed Antenna System (DAS) to interconnect one or more antennas located within the enclosed space, providing coverage to the service provider's subscribers. Multiple service providers may share a single DAS. In the case of large installations such as a major convention center or public transportation facility, a service provided may install base station stations supporting multiple channel sets; this provides multiple “sites” within the space. Some regions within the space may be configurable to be switched among channel sets, typically using a patch panel.

3) A combination of means 1 and 2, above. This would typically be the case when some service providers elect to install base stations in the confined space while others choose to provide service using existing base stations via donor antennas.

It is the nature of many facilities served by such systems that the distribution of wireless subscribers within the confined space varies considerably from time to time. Facilities such as airports and convention centers have a constantly shifting occupancy and thus the distribution of demand for wireless services among regions within the space can vary considerably over time. In the implementations described above, when one channel set (corresponding to its fixed coverage region) is at capacity other(s) will often have unused capacity.

A solution is to manually reconfigure the connections between the base station resources and the antennas in the confined space. A patch panel or manually controlled electronic switch is typically used in these circumstances. This method has been successfully employed in environments in which the changes are predictable and over a short period of time, during which it is feasible to pre-determine the probable distribution of wireless subscribers and to allocate staff to perform the switching function.

Another solution is to reassign traffic channels from a channel set with excess capacity to a channel set with insufficient capacity, as taught in the satellite communications environment by Knudsen (U.S. Pat. No. 5,488,621) and in the cellular environment by Knudsen (U.S. Pat. No. 6,233,041) and Zadeh (U.S. Pat. No. 6,266,531). This requires duplicate equipment in the associated base stations and complex switching logic in the base station and/or its switching controller.

Another solution is to retain the number of channels in each group and to reassign physical areas within the served space to a channel set with excess capacity. Such an approach to be implemented on a wide area site basis is taught by Reudnik et al (U.S. Pat. No. 5,884,147). This approach is based on sophisticated beam-forming antenna technology and requires direct interface with the service provider's base station subsystem to perform its function. An implementation that allocates bandwidth and thereby subscriber capacity based on measurements at the base station site is taught by Salonaho (U.S. Pat. No. 6,317,600). Such an interface is not available if a donor antenna is used. Implementations employing dedicated base stations within a confined space typically serve multiple service providers via a common Distributed Antenna System, requiring multiple interfaces to service providers' equipment.

### SUMMARY

In accordance with the present invention a method is provided to transition regions of the confined space among available channel sets based on measurements from which are derived estimates of subscriber activity in each channel set.

The confined space consists of one or more regions. Each region provides service to wireless subscribers, typically through one or more internal antennas and/or through radiating coaxial cable. At least one of these regions can be switched among two or more channel sets.

Measurements of overall subscriber activity can be made by one, or a combination of several, means. In the context of this invention, a channel is considered to be a base station to mobile subscriber communication path, the physical characteristics of which will differ based on the technology employed by each service provider. In the case of a Time Division Multiple Access (TDMA) system, a channel consists of one or more time slots in a TDMA frame. In the instance of a Code Division Multiple Access (CDMA) system, a channel is defined by one or more pseudorandom codes such as Walsh codes and timing offsets as employed in the TIA/EIA-95 standard.

A measurement of signal strength within the radio spectrum used by one or more service provider(s) can be made in the downlink (base station to mobile subscriber) spectrum or in the uplink (mobile subscriber to base station) spectrum. The means of evaluating the subscriber loading on a channel set can be limited to specific RF frequencies or can encompass the entire range of frequencies employed by one or more service providers. Though a power measurement will not strictly be proportional to the number of subscriber calls active in the channel set, a quantitative comparison of activity between channel sets can reasonably be made. The relationship between the composite power in a particular channel set and the number of active calls in a channel varies depending on the air interface technology employed by the service provider. Typically the relationship is close to proportional in a TDMA network. The relationship may be more logarithmic in CDMA networks, since a considerable portion of the composite power is allocated to overhead channels such as the pilot, paging, and synchronization channels used in the TIA/EIA-95 standard. Thus if multiple service providers are combined into the Distributed Antenna System it may be advantageous, though not necessary, to utilize different algorithms to evaluate channel sets using different technologies. In some implementations, the signals to be evaluated may be in the form of down-converted, optical, or digital representations of the radio frequency signals used in the wireless system.

Mobile subscribers outside the enclosed space may also be served by the channel set and power from their upstream transmissions will not be present in the upstream path within the confined space. In such a case it may be advantageous to more heavily weight the downlink composite signal strength or to ignore the upstream path altogether. This is typically the case when a donor antenna is employed to utilize capacity of an existing cell site.

A second means of determining radio frequency channel set loading is to monitor activity on one or more of the channels used for setting up calls in the radio frequency channel set with which it is associated. This would typically encompass the radio frequency channels allocated to a wireless site or to a sector within a site.

A third means of evaluating channel set loading is a direct interface with the base station associated with the radio frequency channel set or its controller. Though more precise than the other methods, this will seldom be available in such a system, and the complexity in implementing it for multiple service providers employing multiple technologies and equipment from multiple vendors is considerable. Though this method is in the prior art, in the context of the present invention this means can be used in combination with one or more of the indirect means described.

### OBJECTS AND ADVANTAGES

Several objects and advantages of the present invention are:

(a) to provide a means of allocating wireless resources among covered regions without direct connection to the wireless network;

(b) to permit allocation of wireless resources among covered regions in an unpredictable environment in which wireless demand may depend on events such as airline arrivals and departures or adjournment of conference sessions;

(c) to eliminate the need for human intervention in re-allocating wireless resources among covered regions; and

(d) to simultaneously support multiple service providers; and

(e) to simultaneously support multiple wireless technologies.

### BRIEF DESCRIPTION OF THE DRAWINGS

FIG. 1 shows a manual means of optimizing the loading of two channel sets in three coverage areas.

FIG. 2a shows a typical on-site base station implementation using multiple channel sets for each of multiple wireless service providers.

FIG. 2b shows a space served by a combination of on-site base stations and donor-site resources.

FIG. 3 shows a simple implementation of the present invention.

FIG. 4 shows the components of the control and switching mechanism depicted in FIG. 3.

FIG. 5 shows a more flexible implementation providing switching of N channel sets among M regions.

FIG. 6 shows the components of the programmable monitor/control unit depicted in FIG. 5.

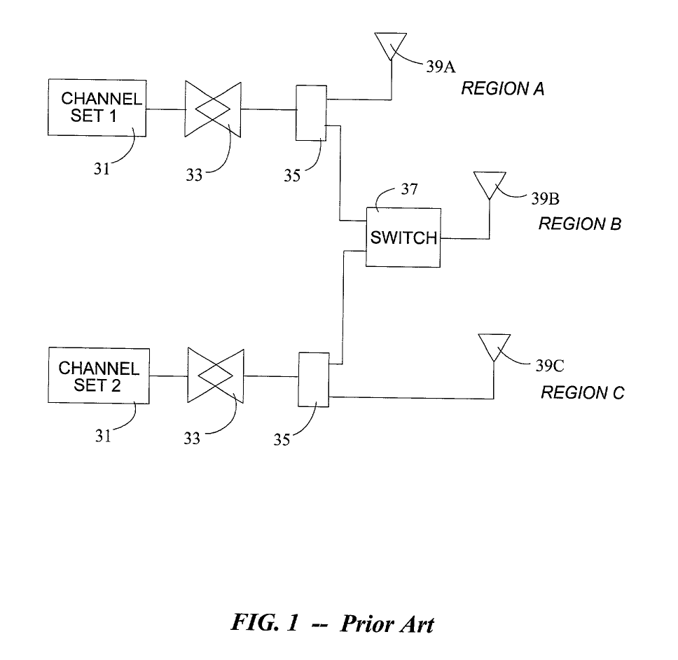

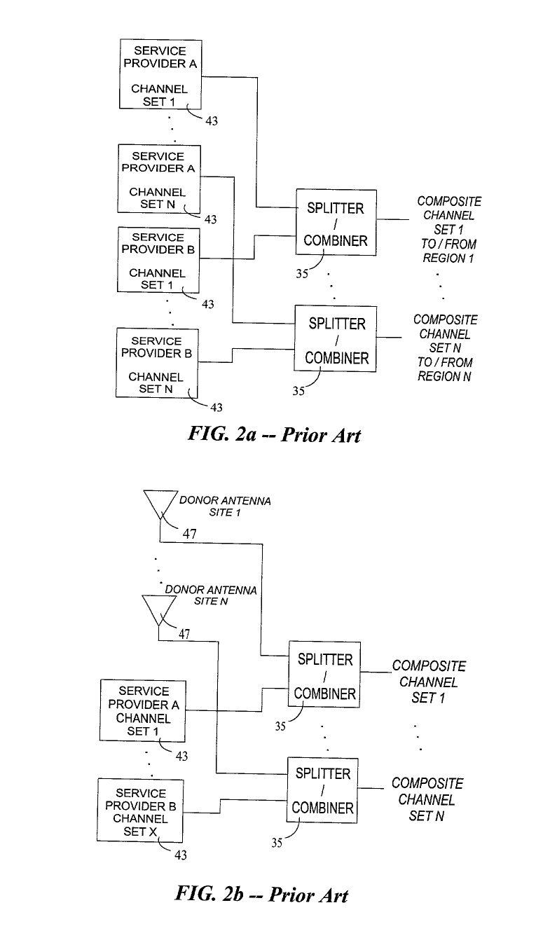

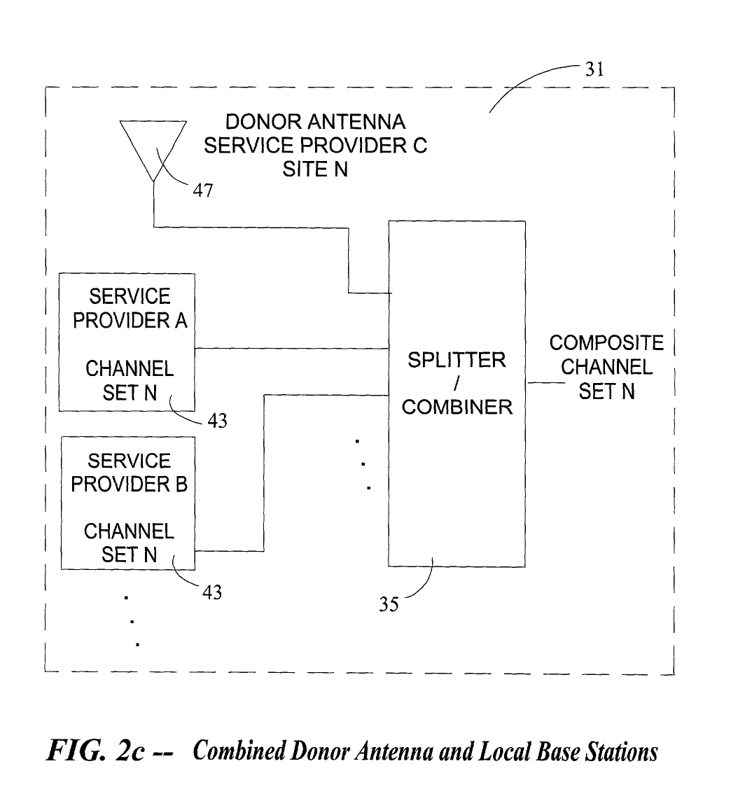

REFERENCE NUMERALS IN DRAWINGS

| | |
|---|---|
| 31 | radio frequency channel set |
| 33 | bi-directional amplifier |
| 35 | radio frequency splitter/combiner |
| 37 | radio frequency switch |
| 39 | serving antenna |
| 43 | multi-channel base station |
| 47 | donor antenna |
| 49 | monitor/control unit |
| 51 | power detector |
| 53 | controller |
| 55 | switch |
| 57 | programmable monitor/control unit |
| 59 | multi-port switch |
| 61 | switch control signal |
| 63 | resource allocation logic |

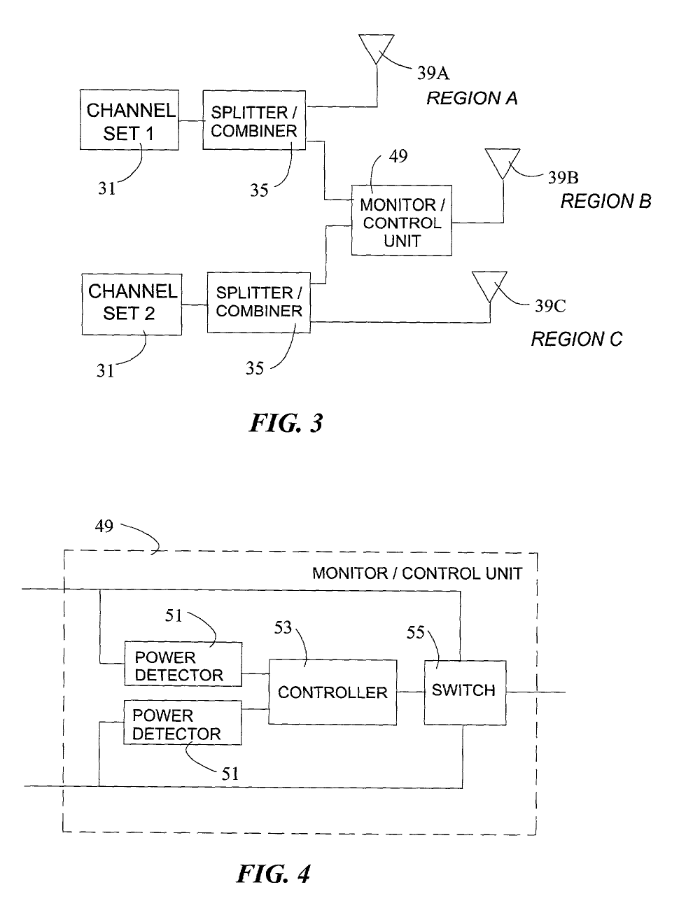

### DESCRIPTION—FIGS. 3 AND 4—PREFERRED EMBODIMENT

A preferred embodiment of the present invention is illustrated in FIG. 3. Each radio set 31 is applied to splitter/combiner 35. One output of each splitter/combiner is connected directly to serving antennas 39A and 39C, each serving a region of the confined space. The other output of each splitter/combiner 35 is connected to a monitor/control unit 49. The output of monitor/control unit 49 is connected to serving antenna 39B, which serves subscribers within its region of the confined space. In a donor-site system, fixed regions A 39a and B 38b may not exist; the entire confined space may be switched to the least heavily loaded macro-site.

The components of the monitoring/logic unit are shown in FIG. 4. Power detectors 51 monitor the radio frequency levels of their respective radio frequency channel sets. Power detectors 51 respond to radio frequency energy in the downlink (base station to subscriber handset) frequency band. The outputs of power detectors 51 are compared by controller 53 to determine which of respective radio frequency channel sets 31 are less heavily loaded. Though not explicitly shown, a weighting factor may be applied to each power detector output within the comparator to compensate for differences in losses from the base station, the number of channels in each channel set, and other factors. Hysteresis and time delay will typically be incorporated into controller 53 to prevent instability. Controller 53 controls switch 55, connecting the less heavily loaded radio frequency channel set 31 to serving antenna 39B associated with region B. In this way, the less heavily loaded radio frequency channel set 31 is used within region B.

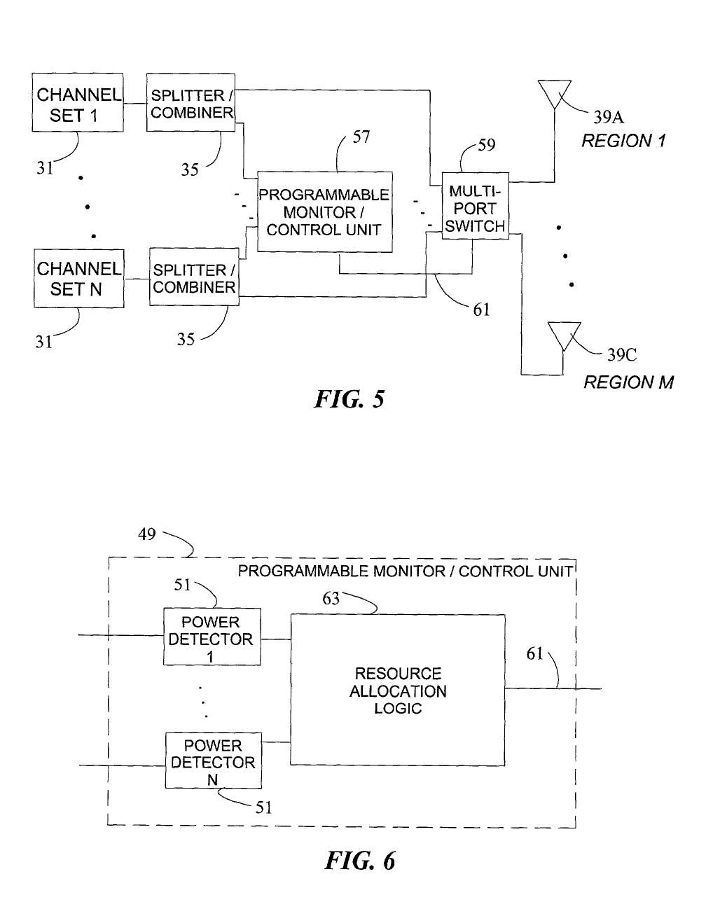

### FIGS. 5-6—ADDITIONAL EMBODIMENTS

FIGS. 5 and 6 show a more complex, but more flexible implementation. In this embodiment, an arbitrary number N of radio frequency channel sets 31 are applied to programmable monitoring/control unit 57. Programmable monitoring and control unit 57 evaluates the outputs of power detectors 51 in resource allocation logic 63 to determine the desired selection of radio frequency channel sets 31 to each region of the confined space. One or more switch control signals 61 are generated to control multi-port switch 59. Multi-port switch 59 connects N radio frequency channel sets 31 among M serving antennas 39. In practice, some regions may be permanently allocated to one or more radio frequency channel sets 31 while others will be allocated by resource allocation logic 63 based on current subscriber loading.

### ADVANTAGES

Several advantages over the prior art are:

(a) Direct connection to the wireless network is not required.

(b) Operation does not require human intervention.

(c) Operation can be performed independent of wireless technologies used in the air interface.

(d) Multiple networks using multiple air interface technologies are accommodated.

### OPERATION—FIGS. 3, 4, 5, 6

Power detector 51 measures the total power in its associated channel set 31. Outputs of each power detector 51 are processed in controller 53. Power may be measured in either the downlink (base station to handset) or uplink (handset to base station) direction, or any pre-determined combination. Controller 53 compares the power in each channel set 31. A weighting factor may be applied to the outputs of one or more power detectors to compensate for differences in base station signal levels, number of RF channels in the channel set, and other considerations. Though switching could be instantaneous based on a simple comparison, it is anticipated that time delay and/or hysteresis will be incorporated within controller 53 to prevent instability. Controller 53 controls the position of switch 55, switching the less heavily loaded channel set 31 to one or more antennas in its associated region. In the simplest implementation, only one region (region B 39B) may exist.

In the more complex implementation shown in FIGS. 5 and 6, a programmable monitor/control unit 57 evaluates the outputs of power detectors 51 to determine the best allocation of channel sets 31 within the confined space. N×M multi-port switch 59 routes channel sets 31 to multiple regions 39 via switch control signal 61.

In most implementations, instantaneous switching is undesirable to prevent dropping existing calls in a region 39 that is being switched to a new channel set 31. Switching will be done gradually to permit the service provider's base station network to sense the transition and to implement its handoff process to transition existing calls to new channel set 31.

### CONCLUSIONS, RAMIFICATIONS, AND SCOPE

The method described in this invention provides optimization of the capacity of one or more wireless networks that are served by an in-building distributed antenna system. Subscriber traffic loading is sensed indirectly by sensing the call loading on each channel set and by switching one or more regions to the less-loaded channel set. The advantages of this method are evident:

Calls on the service providers' networks are more evenly distributed among its channel sets, providing improved capacity and call quality both in the enclosed environment and in the outside regions served by these channel sets.

Higher capacity is provided within an in-building environment by re-allocating channel sets, shifting capacity to regions where it is needed.

Manual intervention is not required to optimize network performance.

This method can be used to enhance existing means of reallocating capacity, such as time scheduling. This can compensate for schedule changes, late arrivals at an airport, and one-time events.

The configuration of the in-building network is responsive to channel set loading changes in the outside environment. Use of heavily loaded channel sets will be minimized in the in-building environment.

Although the description above contains many specificities, these should not be construed as limiting the scope of the invention but as merely providing illustrations of some of the presently preferred embodiments of this invention. For example, channel set loading can be estimated by other indirect means such as decoding the control channel and calculating a moving average of call originations; channel set loading can be estimated by any combination of downstream and upstream signal levels; signal paths may constitute digitized data streams that can be analyzed to determine signal levels; the regions supported by this invention can be portions of a tunnel or a remote outside space, etc.

Thus the scope of the invention should be determined by the appended claims and their legal equivalents, rather than the examples given.

I claim:

1. A method for dynamically allocating a plurality of wireless channel sets within a served area which is responsive to subscriber traffic loading on said channel sets, each of said channel sets providing wireless communication services to subscribers to one or more wireless service providers, said method consisting of the steps of:
(a) providing a means of estimating the subscriber traffic loading on each of said channel sets without direct interface to at least one wireless communications service network, and
(b) providing a means to determine if more efficient use of said channel sets can be made by redistributing said channel sets among radiating elements in said served area, and
(c) providing a means to control the distribution of said channel sets among said radiating elements in said served area.

2. The method of claim 1, wherein said means of estimating said subscriber traffic loading of one or more of said channel sets is derived from the measurement of radio frequency signal strength of said channel sets.

3. The method of claim 1, wherein said means of estimating said subscriber traffic loading of one or more of said channel sets is derived from the measurement of optical signal strength of said channel sets.

4. The method of claim 1, wherein said means of estimating said subscriber traffic loading of one or more of said channel sets is derived from monitoring a digital representation of the waveform of said channel sets.

5. The method of claim 1, wherein said means of estimating said subscriber traffic loading of one or more of said channel sets is derived by decoding at least one control channel associated with said channel sets.

6. The method of claim 1, wherein said estimate of said subscriber traffic loading of one or more of said channel sets is obtained directly from the wireless network controlling said channel set.

7. The method of claim 1, wherein said means to determine if more efficient use of said channel sets can be made incorporates non-real-time considerations.

8. The method of claim 1, wherein said means to determine if more efficient use of said channel sets can be made includes hysteresis.

9. The method of claim 1, wherein said means to determine if more efficient use of said channel sets can be made includes a prediction based on history of said subscriber traffic loading.

10. The method of claim 1, wherein said means of redistribution of said channel sets performs switching of radio frequency signal paths.

11. The method of claim 1, wherein said means of redistribution of said channel sets performs switching of optical signal paths.

12. The method of claim 1, wherein said means of redistribution of said channel sets performs switching of digital signal paths.
